(19) United States
(12) Patent Application Publication
(10) Pub. No.: US 2007/0025876 A1
(43) Pub. Date: Feb. 1, 2007

(54) Chemical analysis device and chemical analysis cartridge

(76) Inventors: Noriyo Nishijima, Abiko (JP); Yoshihiro Nagaoka, Ishioka (JP); Shigeyuki Sasaki, Kasumigaura (JP); Michihiro Saito, Kashiwa (JP); Satoshi Takahashi, Hitachinaka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/493,751

(22) Filed: Jul. 27, 2006

(30) Foreign Application Priority Data
Jul. 29, 2005 (JP) 2005-219861

(51) Int. Cl. G01N 35/00

(52) U.S. Cl. 422/64; 422/58

(57) ABSTRACT

An analysis cartridge for use in a chemical analysis device comprises a reagent cartridge having a plurality of reagent containers formed therein to be able to contain reagents, and a reaction cartridge connected to the reagent cartridge and having a reaction container formed therein. The reagent cartridge and the reaction cartridge are each made up of a base plate and a cover covering recesses formed in a surface of the base plate. Channels for interconnecting the plurality of reagent containers and the reaction container are formed in the reagent cartridge and the reaction cartridge. The channels are formed inside the base plates of the reagent cartridge and the reaction cartridge in their connected portions. The structure of the analysis cartridge for mixing and reacting a specimen and reagents can be simplified.

### BACKGROUND OF THE INVENTION

1. Field of the Invention

The present invention relates to a chemical analysis device and a chemical analysis cartridge for use in the chemical analysis device. More particularly, the present invention relates to a biochemical analysis device suitable for an automatic analysis and an analysis cartridge for use in the biochemical analysis device.

2. Description of the Related Art

One example of known biochemical analysis devices is disclosed in Patent Document 1 (PCT Laid-Open Publication No. 00/78455). According to the disclosed method of extracting DNA from a liquid specimen containing the DNA, after passing a DNA mixed liquid through a glass filter as an inorganic base member, a cleaning liquid and an elution liquid are passed through the glass filter to recover only the DNA. The glass filter is placed in a rotatable structure, and reagents, such as the cleaning liquid and the elution liquid, are held in respective reagent reservoirs. The reagents are forced to flow by centrifugal forces generated with rotation of the structure and to pass through the glass filter upon opening of valves which are disposed in micro-channels connecting the reagent reservoirs and the glass filter.

Another example of known biochemical analysis devices is disclosed in Patent Document 2 (JP,A 2001-527220). In the disclosed biochemical analysis device, a particular chemical substance, e.g., a nucleic acid, is extracted for analysis from a specimen containing a plurality of chemical substances. An integral-type cartridge includes reagents, such as a lysis reagent, a cleaning liquid and an elution liquid, and a capture component for capturing the nucleic acid. After pouring the sample containing the nucleic acid into the cartridge, the specimen and the elution liquid are mixed with each other and are passed through the capture component, and the cleaning liquid is then passed through the capture component. Thereafter, the elution liquid is passed through the capture component. The elution liquid having passed through the capture component is brought into contact with a PCR reagent and is sent to a reaction chamber.

### SUMMARY OF THE INVENTION

In the device disclosed in Patent Document 1, many valves capable of being operated only once are provided to control flows of the reagents, the DNA mixed liquid, etc. In such a valve, a sealing-off portion is made of, e.g., wax that is melted when heated. Because a flow passage is physically closed by using wax, that valve is advantageous in that a liquid flow can be positively controlled. However, a rotating disk is complicated for the reasons that the sealing-off portion must be provided for each of the valves and some heating means is required to heat the sealing-off portion. Consequently, a device for realizing an analysis sequence is also complicated. Further, since the filter is mounted in the rotating disk, the filter is required to be flexible for facilitation of the filter mounting. This may lead to a risk that the liquid leaks from the filter.

Also, the device disclosed in Patent Document 2 employs an integral-type fluid-operated cartridge. In this cartridge, because a plurality of reagents are supplied from reagent chambers to micro-channels including valves disposed therein, the cartridge must have many valves and the cartridge structure is complicated.

With the view of overcoming the above-described problems in the related art, an object of the present invention is to reduce the size and simplify the structure of a biochemical analysis device. Another object of the present invention is to eliminate the need of complicated valves in a cartridge for use in the biochemical analysis device. Still another object of the present invention is to automatically perform mixing, reacting and detecting steps for many specimens and reagents in the biochemical analysis device. The present invention is intended to achieve at least one of those objects.

To achieve the above objects, the present invention provides a chemical analysis device comprising a rotatable holding disk and a plurality of analysis cartridges arranged side by side along a circumference of the holding disk, wherein each of the plurality of analysis cartridges comprises a reagent cartridge having a plurality of reagent containers formed therein to be able to contain reagents, and a reaction cartridge connected to the reagent cartridge and having a reaction container formed therein, the reagent cartridge and the reaction cartridge being each made up of a base plate and a cover covering recesses formed in a surface of the base plate, and channels for interconnecting the plurality of reagent containers and the reaction container are formed in the reagent cartridge and the reaction cartridge, the channels being formed inside the base plates of the reagent cartridge and the reaction cartridge in connected portions thereof. The present invention also provides the analysis cartridge having the above-mentioned features, which is used in the chemical analysis device.

Further, to achieve the above object, the present invention provides a chemical analysis device comprising a rotatable holding disk and a plurality of analysis cartridges arranged side by side along a circumference of the holding disk, wherein each of the plurality of analysis cartridges comprises a plurality of reagent containers capable of containing reagents, channels for transferring the reagents toward the outer peripheral side from the reagent containers, and a reaction container connected to the channels and arranged in the outer peripheral side of the reagent containers. The present invention also provides the analysis cartridge having the above-mentioned features, which is used in the chemical analysis device.

Preferably, the reaction cartridge includes a binding section for capturing or binding a material in a specimen, and a filter holder for holding a binding filter is detachably attached to the binding section, the filter holder being arranged such that the binding filter is inserted in a direction inclined from the radial direction of the holding disk when the analysis cartridge is used in the chemical analysis device. Preferably, each of the channels connected to the reagent containers is a turned-back channel extending toward the inner peripheral side to some extent and further extending toward the outer peripheral side, and a channel enlarged portion having an increased channel sectional area is formed in a portion of the turned-back channel extending toward the inner peripheral side. In addition, the turned-back channel has a narrowed portion formed in a portion extending toward the outer peripheral side. Preferably, each of the channels connected to the reagent containers is a turned-back channel connected to the reagent container at an outer peripheral portion thereof, extending toward the inner peripheral side to some extent, and further extending toward the outer peripheral side, and an air channel and a retreat container connected to the air channel are provided in the course of the turned-back channel or at an end of a channel branched from the reagent container, the retreat container being arranged in the more inner peripheral side than an outer peripheral end of the reagent container.

According to the present invention, in the analysis cartridge, flows of the reagents and the specimen from the respective containers (chambers) to the reaction container (analysis section), etc. through the channels are controlled by utilizing centrifugal forces acting upon the analysis cartridge. Therefore, complicated valves are no longer required, and the analysis cartridge and the chemical analysis device employing the analysis cartridge can be downsized and simplified. Also, mixing, reacting and detecting steps for many specimens and reagents can be automatically carried out just by rotating the analysis cartridge.

### BRIEF DESCRIPTION OF THE DRAWINGS

FIG. 1 is a perspective view of a gene analysis device according to one embodiment of the present invention;

FIG. 2 is a perspective view of an analysis cartridge for used in the gene analysis device shown in FIG. 1;

FIG. 3 is an exploded perspective view of the analysis cartridge shown in FIG. 2;

FIG. 4 is a partial vertical sectional view of the analysis cartridge shown in FIG. 2;

FIG. 5 is a flowchart showing operation procedures of the gene analysis device according to the embodiment of the present invention;

FIG. 6 is a flowchart showing operation procedures of the gene analysis device according to the embodiment of the present invention;

FIG. 7 is a plan view of the analysis cartridge shown in FIG. 2;

FIG. 8 is a plan view of the analysis cartridge shown in FIG. 2;

FIG. 9 is a partial plan view of the analysis cartridge shown in FIG. 2;

FIG. 10 is a partial plan view of the analysis cartridge shown in FIG. 2;

FIG. 11 is a plan view of the analysis cartridge shown in FIG. 2;

FIG. 12 is a perspective view of the analysis cartridge shown in FIG. 2;

FIG. 13 is an exploded perspective view of a filter holder used in the analysis cartridge shown in FIG. 2;

FIG. 14 is a plan view of the analysis cartridge shown in FIG. 2;

FIG. 15 is a plan view of the filter holder shown in FIG. 13;

FIG. 16 is a plan view of the analysis cartridge shown in FIG. 2;

FIG. 17 is a partial plan view of the analysis cartridge shown in FIG. 2;

FIG. 18 is a partial vertical sectional view of the analysis cartridge shown in FIG. 2; and

FIG. 19 is a partial plan view of the analysis cartridge shown in FIG. 2.

### DESCRIPTION OF THE PREFERRED EMBODIMENTS

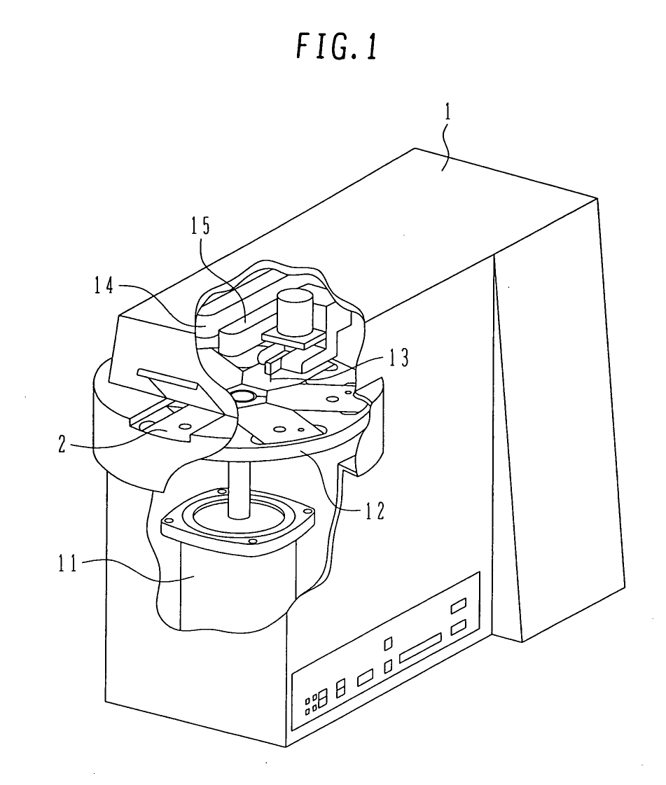

A chemical analysis device and a cartridge for use in the chemical analysis device according to one embodiment of the present invention will be described below with reference to the drawings. This embodiment represents the case where the chemical analysis device is a biochemical analysis device, specifically a gene analysis device 1. FIG. 1 is a perspective view of the gene analysis device 1. The gene analysis device 1 comprises a motor 11 with an output shaft arranged to extend vertically, and a holding disk 12 mounted to the output shaft of the motor 11 and rotated by the motor 11. A plurality of analysis cartridges 2 having the same shape are arranged side by side in the circumferential direction of the holding disk 12. A piercing unit 13 for controlling flows of various liquids is disposed in a position above the analysis cartridges 2 to be able to face any of channels or chambers formed in each of the analysis cartridges 2. Further, a humidifier 14 and a detector 15 are disposed above the analysis cartridges 2.

In analysis using the gene analysis device 1, i.e., the biochemical analysis device, constructed as described above, an operator prepares the analysis cartridge 2 corresponding to inspection or analysis items and mounts it to the holding disk 12. The mounted analysis cartridge 2 is subjected to the analysis such that reagents and a specimen are forced to flow through channels formed in the analysis cartridge 2 with start/stop of rotation of the motor 11 and operation of the piercing unit 13. Gene analysis of the specimen in the form of a fluid is thereby performed.

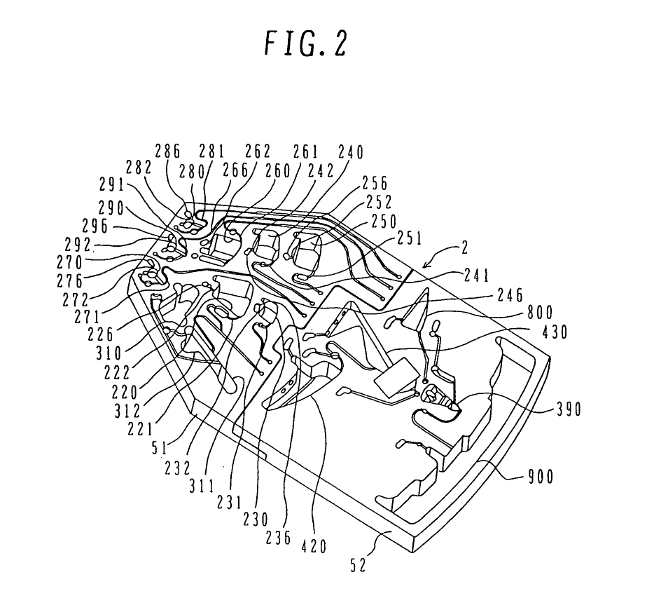

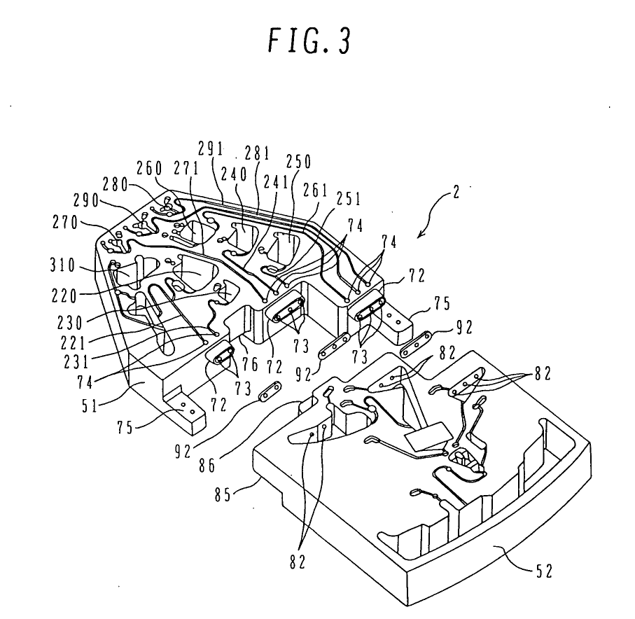

Details of the analysis cartridge 2 for use in the gene analysis device 1 are shown in a perspective view of FIG. 2 and an exploded perspective view of FIG. 3. The analysis cartridge 2 comprises a reaction cartridge 52 being nearly rectangular and having substantially parallel edges, and a reagent cartridge 51 having a nearly sector shape and narrowing toward one end. The reagent cartridge 51 and the reaction cartridge 52 are connected to each other in advance prior to start of the analysis. Then, the analysis cartridge 2 is mounted to the holding disk 12 with the reagent cartridge 51 positioned toward the center of the holding disk 12 of the gene analysis device 1. The central side of the holding disk 12 is the upstream side.

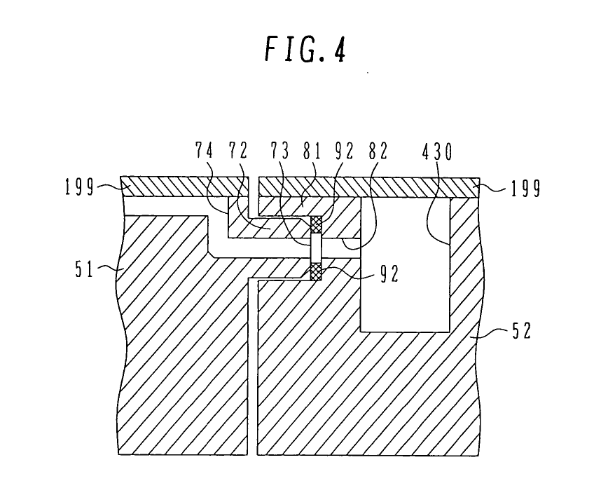

Recesses and projections are formed on an upper surface of the analysis cartridge 2. A cartridge cover (denoted by 119 in FIG. 4) formed of, e.g., a film or a thin sheet is arranged to cover the entire upper surface of the analysis cartridge 2 such that enclosed channels and containers for reagents, etc. are formed in combination of the cartridge cover with the recesses and the projections. The cartridge cover is bonded or joined to the analysis cartridge 2.

A plurality of reagent containers 220-290 for containing reagents required for the analysis are formed in the reagent cartridge 51 of the analysis cartridge 2. Predetermined quantities of reagents are poured in the reagent containers 220-290 in advance.

Outlet channels 221-291 connected respectively to the reagent containers 220-290 are formed as turned-back channels such that the reagents are forced to temporarily flow toward the inner peripheral side after exiting the reagent containers 220-290, and then to reversely flow toward the reaction cartridge 52. The outlet channels 221-291 are extended up to connectors 72 formed on an end surface of the reagent cartridge 51. Air channels 222-292 are formed in the inner peripheral side of the reagent containers 220-290, respectively. Spaces 226-296 adapted for piercing and having larger sectional areas than the air channels 222-292 are formed at respective ends of the air channels 222-292.

A specimen container 310 for supplying whole blood, i.e., a specimen, to the analysis cartridge 2 is formed in the reagent cartridge 51. Downstream of the specimen container 310, a serum unit quantity container 312 and a hemocyte storage container 311 for treating the reagents and the specimen in accordance with predetermined operation procedures are formed adjacent to each other.

A serum reaction container 420 for reacting the reagent and the specimen, a before-binding container 430, a buffer container 800, and an elution liquid recovery container 390 are formed in the reaction cartridge 52. A waste container 900 is formed in the outermost peripheral side of the analysis cartridge 2 substantially over its entire width. Channels are connected to those containers such that the reagents and the specimen can be forced to flow from those containers through the channels in accordance with the predetermined operation procedures.

Assembly steps of the analysis cartridge 2 having the above-described structure will be described below. Predetermined quantities of reagents are poured in the reagent containers 220-290 in advance. The containers and the channels formed as recesses in both the reagent cartridge 51 and the reaction cartridge 52 are entirely sealed off by a cartridge cover 199 (see FIG. 4). Reagent-cartridge side connectors 72 for connecting the reagent cartridge 51 and the reaction cartridge 52 to each other are provided on the end surface of the reagent cartridge 51. The reagent-cartridge side connectors 72 are kept sealed off by connection port sealing-off members (not shown) until the reagent cartridge 51 is used. Thus, the reagents poured in the reagent cartridge 51 are preserved in a state enclosed inside the reagent cartridge 51 until the time of use.

For joining the reagent cartridge 51 and the reaction cartridge 52 to each other, reagent-cartridge side joint projections 75 are projected from opposite side areas of the end surface of the reagent cartridge 51 which is positioned to face the reaction cartridge 52. Further, a reagent-cartridge side joint recess 76 is formed in a central area of the end surface of the reagent cartridge 51.

Reaction-cartridge side joint recesses 85 are formed in opposite side areas of an end surface of the reaction cartridge 52, which is positioned to face the reagent cartridge 51, to be engaged with the reagent-cartridge side joint projections 75. Further, a reaction-cartridge side joint projection 86 is provided in a central area of the end surface of the reaction cartridge 52 to be engaged with the reagent-cartridge side joint recess 76.

Immediately before connecting the reagent cartridge 51 and the reaction cartridge 52 to each other, the connection port sealing-off members are peeled from the reagent-cartridge side connectors 72. The reagent-cartridge side connectors 72 have reagent-cartridge side connection ports 73. Connection preparation channels 74 for communicating the channels led to the reagent containers 220-290 with the reagent-cartridge side connection ports 73 are formed in an end portion of the reagent cartridge 51 which is positioned close to the reaction cartridge 52. Incidentally, each of the reagent-cartridge side connectors 72 has a plurality of reagent-cartridge side connection ports 73. The connection preparation channels 74 are formed at respective ends of the channels 221-291 formed in the upper surface of the reagent cartridge 51. Each of the connection preparation channels 74 has a hole portion substantially vertically extending from the upper surface of the reagent cartridge 51 and a horizontal portion extending from the hole portion for communication with the corresponding reagent-cartridge side connection port 73.

The reaction cartridge 52 has reaction-cartridge side connectors 81 which have the recessed form in complementary to the reagent-cartridge side connectors 72 and are fitted with the reagent-cartridge side connectors 72. Reaction-cartridge side connection ports 82 are formed in bottom surfaces of the reaction-cartridge side connectors 81. The reaction-cartridge side connection ports 82 are communicated with the serum reaction container 420, the before-binding container 430, and the buffer container 800.

The reagent cartridge 51 and the reaction cartridge 52 are combined, connected and fixed to each other at their connectors and joint portions. A method of fixing the two cartridges can be performed, for example, by pressing the reagent-cartridge side connectors 72 into the reaction-cartridge side connectors 81. Because the reaction-cartridge side connectors 81 are each in the form of a recess, a packing 92 is placed in the recess beforehand. In other words, just by combining the reagent-cartridge side joint projections 75 with the reaction-cartridge side joint recesses 85 and combining the reagent-cartridge side joint recesses 76 with the reaction-cartridge side joint projections 86, respectively, the reagent cartridge 51 and the reaction cartridge 52 can be easily connected to each other.

A connected state of the reagent cartridge 51 and the reaction cartridge 52 is shown in a partial vertical sectional view of FIG. 4. The reaction-cartridge side connection port 82 forms a channel communicating with the before-binding container 430, and the reagent-cartridge side connector 72 is fitted with the reaction-cartridge side connector 81. The channel formed in the upper surface of the reagent cartridge 51 is changed in flow direction from the vertical to the horizontal by the L-shaped connection preparation channel 74 before reaching the reagent-cartridge side connection port 73. With such an arrangement, the reagent-cartridge side connection port 73 can be positioned away from the cartridge cover 199. If the L-shaped connection preparation channel 74 is not provided, the reagent-cartridge side connection port 73 and the reaction-cartridge side connection port 82 must be covered at their upper surfaces with the cartridge cover 199 to form those ports, thus resulting in a difficulty in inserting the packing 92 and fixedly fitting the two cartridges by pressing. Accordingly, it is also difficult to realize the connection causing no leakage.

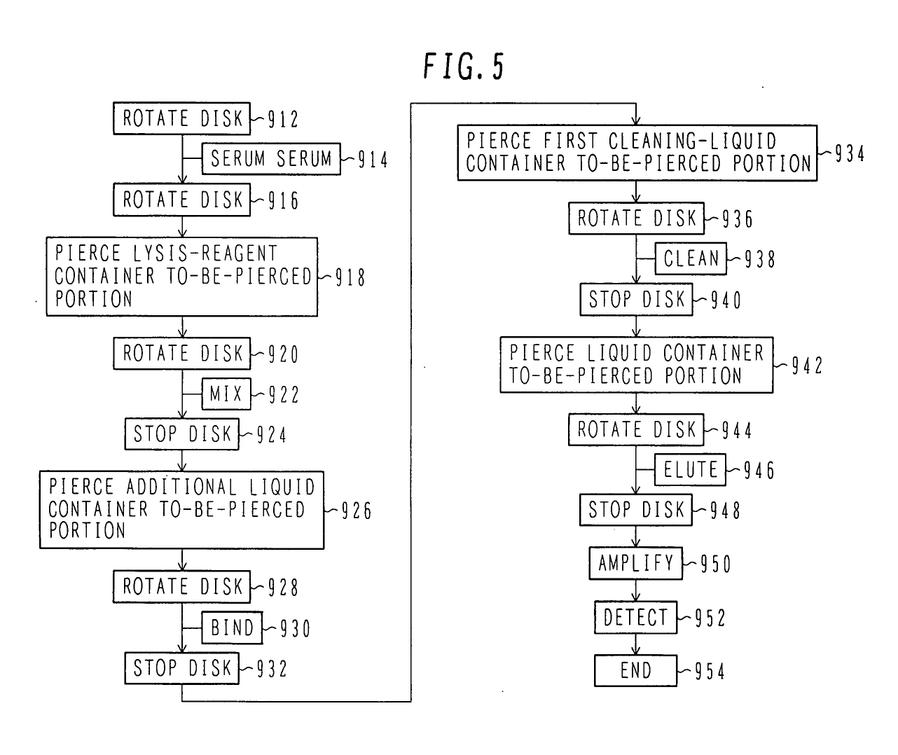

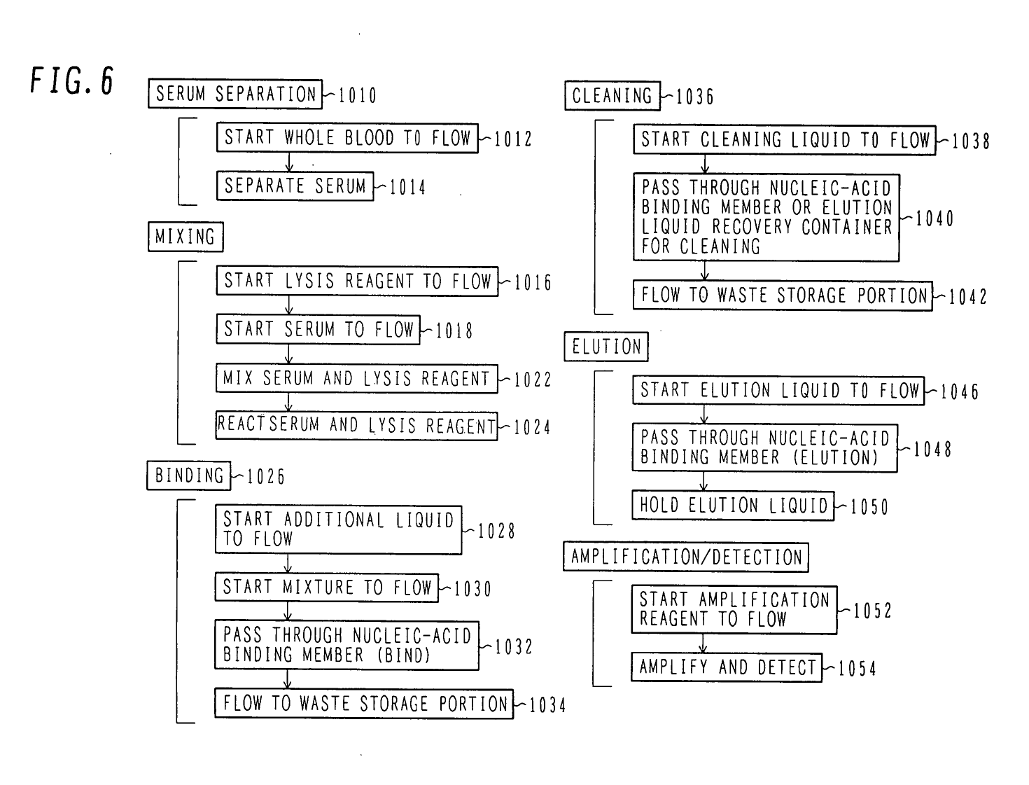

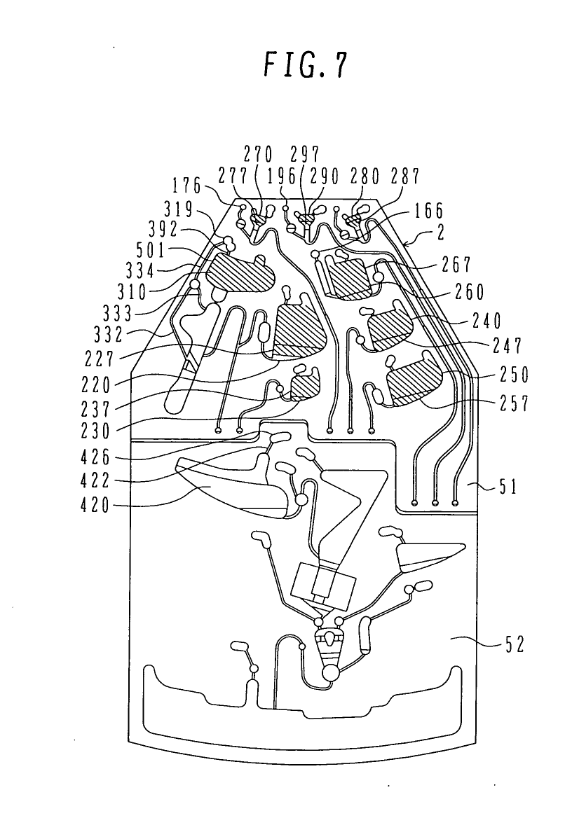

After connecting and fixing the reagent cartridge 51 and the reaction cartridge 52 to each other, the analysis cartridge 2 is mounted in necessary number to the holding disk 12. The manner of extracting and analyzing virus nucleic acids by using whole blood as a specimen will be described below with reference to the flowcharts shown in FIGS. 5 and 6 and plan views of the analysis cartridge 2 shown in FIGS. 7-12 and 17.

(1) Prior to starting the analysis, as shown in FIG. 7, the operator pours whole blood 501, which has been collected by using a vacuum blood-collection tube, into the specimen container 310 of the analysis cartridge 2 through a specimen pouring inlet. At that time, the cartridge cover 199 positioned above the specimen pouring inlet is pierced by using the piercing unit 13 so that the specimen pouring inlet is opened to the outside. After pouring the whole blood 501, the specimen pouring inlet is closed by applying a seal, a cap or the like from above in order to prevent the whole blood from scattering to the outside of the analysis cartridge 2. Predetermined quantities of a lysis reagent 227, an additional liquid 237, a first cleaning liquid 247, a second cleaning liquid 257, a third cleaning liquid 267, an elution liquid 277, a first amplification liquid 297, and a second amplification liquid 287 are previously poured in respective reagent containers, i.e., a lysis reagent container 220, an additional liquid reagent container 230, a first cleaning liquid container 240, a second cleaning liquid container 250, a third cleaning liquid container 260, an elution liquid container 270, a first amplification liquid container 290, and a second amplification liquid 280.

(2) Then, the cartridge cover 199 covering a specimen container to-be-pierced portion 319 and a serum reaction container to-be-pierced portion 426 are pierced by using the piercing unit 13. The specimen container to-be-pierced portion 319 and the serum reaction container to-be-pierced portion 426 are thereby communicated with open air. While the piercing unit 13 is used in this embodiment to mechanically pierce the to-be-pierced portion, the to-be-pierced portion may be communicated with open air by melting the cartridge cover under application of heat or by forming an opening in the cartridge cover with the aid of other suitable means. Also, while open air and air inside the cartridge are communicated with each other by piercing in this embodiment, it is essential that air is able to freely pass through the to-be-pierced portion. Thus, air in the to-be-pierced portion may be communicated with, instead of open air, another space separately formed on the cartridge or another portion to be pierced.

At that time, portions of the cartridge cover 199 covering an elution liquid retreat container to-be-pierced portion 176, a first amplification-liquid retreat container to-be-pierced portion 196, a second amplification-liquid retreat container to-be-pierced portion 186, and a third cleaning-liquid retreat container to-be-pierced portion 166 are also pierced. The reasons why those four portions are pierced will be described later.

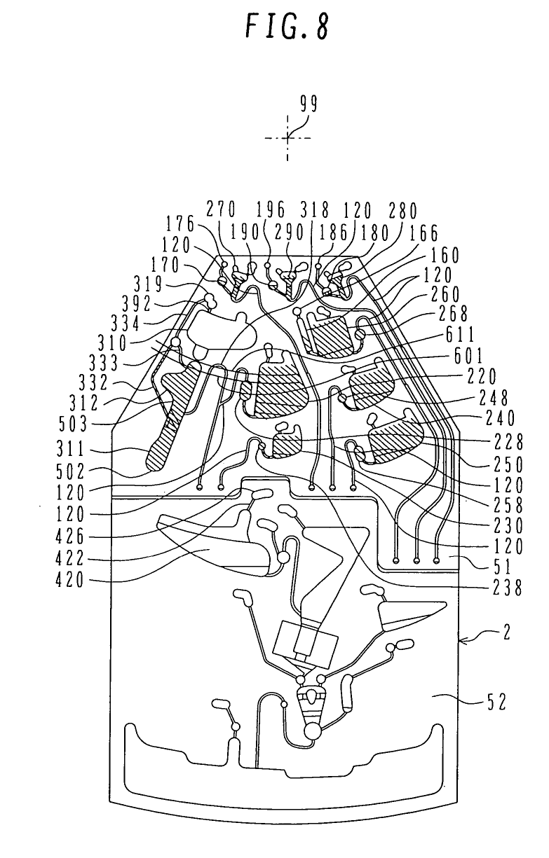

(3) Separation of serum (step 1010 in FIG. 6): The motor 11 of the gene analysis device 1 is driven to rotate the holding disk 12 (step 912 in FIG. 5 and step 1012 in FIG. 6, this relation is also similarly applied to the following description). Under a centrifugal force generated with the rotation of the holding disk 12, the whole blood 501 poured in the specimen container 310 receives a force acting outward from a center 99 of the rotation in the radial direction and flows toward the outer peripheral side (see FIG. 8). Further, the whole blood 501 flows into the serum unit quantity container 312 communicating with the specimen container 310 and then into the hemocyte storage container 311 communicating with the serum unit quantity container 312.

The quantity of the poured specimen, i.e., the poured whole blood 501, is set such that the hemocyte storage container 311 and the serum unit quantity container 312 are just filled with the whole blood 501. A liquid level 601 of the whole blood 501 in the analysis cartridge 2 is held by the action of the centrifugal force to position in match with a concentric circumference about the center 99 of the rotation of the holding disk 12. In consideration of the above, a turned position of a serum unit-quantity container turned-back channel 318 extending from the serum unit quantity container 312 is set to locate in the more inner peripheral side than the liquid level 601. With such an arrangement, when the centrifugal force is applied to the whole blood 501, the whole blood 501 is avoided from flowing toward the outer peripheral side beyond the turned position of the turned-back channel 318 and is held in the hemocyte storage container 311 and the serum unit quantity container 312.

(4) The rotation of the holding disk 12 is continued. The whole blood 501 is centrifugally separated into hemocyte 502 and serum 503 (step 914 and step 1014). The hemocyte 502 is moved into the hemocyte storage container 311, and only the serum 503 remains in the serum unit quantity container 312. During such a series of serum separating operations, a very small quantity of air is left in each of the reagent containers 220-290 of the analysis cartridge 2 along with the reagents 227-297, while no air is flown into the reagent containers 220-290 because the air channels 222-292 are covered with the cartridge cover after filling the reagents. With application of centrifugal forces to the reagent containers 220-290, the reagents 227-297 in the reagent containers 220-290 are biased toward the outer peripheral side. The turned-back channels 221-291 are formed such that respective liquids in the reagent containers 220-290 in such biased states are positioned in the more inner peripheral side than the turned-back channels 221-291 connected to the reagent containers 220-290.

When parts of the reagents 227-297 are caused to flow into the turned-back channels 221-291 by the action of the centrifugal forces, air sealed in at the time of filling the reagents 227-297 is expanded corresponding to volumes of the reagents 227-297 having flown into the turned-back channels 221-291. As a result, air pressures in the specimen containers 220-290 are lowered to become negative. With balance between the negative pressures and the centrifugal pressures, the reagents 227-297 are prevented from flowing out beyond the turned-back channels 221-291. During the serum separating operations, therefore, the reagents 227-297 are positively held in the reagent containers 220-290.

In the turned-back channels 221-261 connected to the reagent containers 240-260 positioned in a side area of the reagent cartridge 51 and to the reagent containers 220 and 230 positioned in a central area thereof, channel enlarged portions 228-268 having enlarged channel section areas are formed midway the respective channels extending toward the inner peripheral side from connected points between the reagent containers 220-260 and the turned-back channels 221-261 (see FIG. 8). Because the formation of the channel enlarged portions 228-268 increases the volumes of the turned-back channels 221-261, air is expandable in larger volume. As a result, the negative pressures are generated at higher levels and the reagents 227-267 can be more positively held in the reagent containers 220-260.

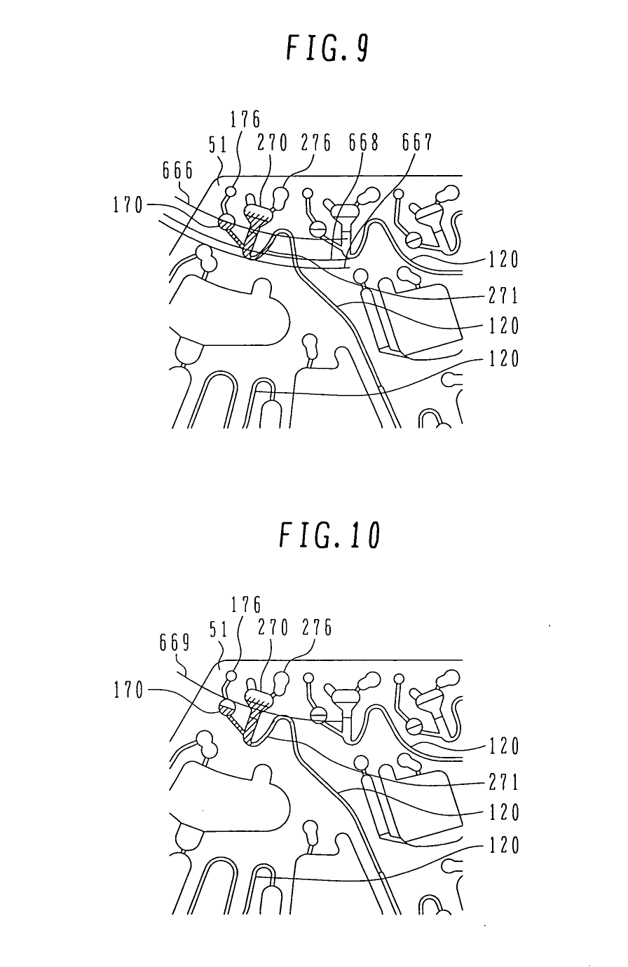

Also, in order to more positively hold the reagents 261-291 in the reagent containers 260-290, a third cleaning liquid retreat container 160, an elution liquid retreat container 170, a second amplification liquid retreat container 180, and a first amplification liquid retreat container 190 are connected to the corresponding reagent containers 260-290. The actions of those retreat containers 160-190 will be described below with reference to FIG. 9, taking the elution liquid retreat container 170 as an example.

The elution liquid container 270 is made up of a circular portion and a bar-shaped portion continuously extending from the circular portion (see FIG. 9). A channel connected to the elution liquid retreat container 170 is branched from a position 668 in the more inner peripheral side than an outermost peripheral position 667 of the bar-shaped portion. The elution liquid retreat container 170 is formed at an inner end of the branched channel in a position slightly closer to the outer peripheral side than the elution liquid container 270. The elution liquid retreat container to-be-pierced portion 176 is connected to the elution liquid retreat container 170 through a channel. The elution liquid retreat container to-be-pierced portion 176 is positioned in the more inner peripheral side than the elution liquid retreat container 170, and it is already pierced by using the piercing unit when serum is separated. At that time, an elution liquid container to-be-pierced portion 276 positioned in the more inner peripheral side than the elution liquid container 270 and connected to the elution liquid container 270 through a channel is not yet pierced.

When the centrifugal force is applied in such a state, as shown in FIG. 9, the elution liquid 277 filled in the elution liquid container 270 is moved toward the outer peripheral side and enters the turned-back channel 271. Similarly, the elution liquid 277 also enters the elution liquid retreat container 170. Because the elution liquid retreat container to-be-pierced portion 176 is now pierced, the elution liquid retreat container 170 is communicated with the outside, and the air in the elution liquid retreat container 170 is evacuated and replaced with the elution liquid 277. As a result, the elution liquid 277 having flown into the turned-back channel 271 and the elution liquid 277 having flown into the elution liquid retreat container 170 have substantially the same liquid level 666. The provision of the elution liquid retreat container 170 allows the elution liquid 277 to flow into the elution liquid retreat container 170 as well and increases the expansion volume of air correspondingly. It is hence possible to generate the negative pressure at a higher level and to more positively prevent the elution liquid 277 from flowing out to the turned-back channel 271.

Thus, the channel enlarged portions 228-268 are formed for the reagent containers 220-260, while the retreat containers 170-190 are provided for the reagent containers 270-290. Such a difference depends on the required quantity of reagent. If the size of the channel enlarged portion is excessively increased when the required quantity of reagent is small, the reagent is more apt to remain in the turned-back channel in the operation of causing the reagent to flow out. To avoid such a drawback, the retreat container is provided for the reagent container containing a small amount of reagent, and the channel enlarged portion is provided for the reagent container containing a large amount of reagent. Since the elution liquid retreat container 170 is connected to the elution liquid container 270 at a position 668 in the more inner peripheral side than the outermost peripheral position 667 of the elution liquid container 270, the liquid having entered the elution liquid retreat container 170 can be all returned to the elution liquid container 270 and the liquid can be avoided from being left uselessly in the operation of piercing the elution liquid container to-be-pierced portion 276 and causing the elution liquid 277 to flow out.

When the cartridge cover 199 covering the reagent container to-be-pierced portions 226-286 is pierced, air is allowed to flow, from the outside, into the reagent containers 220-280 which are connected to the reagent container to-be-pierced portions 226-286 having been pierced, and therefore no negative pressures are generated in the reagent containers 220-280. Accordingly, when the motor 11 is rotated, the reagents 227-287 are forced to flow out toward the downstream side beyond the innermost peripheral portions of the turned-back channels 221-281. Once the reagents 227-287 start to flow out through the turned-back channels 221-281, a siphon is formed and the reagents are all flown out. A turned-back channel narrowed portion 120 having a narrowed channel sectional area is formed in each of the turned-back channels 221-281 at a position midway the channel extending from the innermost peripheral portion toward the downstream side.

The action of the turned-back channel narrowed portion 120 will be described below with reference to FIG. 10 by taking the elution liquid container 270 as an example. When the cartridge cover 199 covering the elution liquid container to-be-pierced portion 276 is pierced and the motor 11 is rotated, no negative pressure is generated in the elution liquid container 270 and the elution liquid 277 is forced to flow out toward the downstream side through the turned-back channel 271. In particular, when the elution liquid 277 passes the innermost peripheral portion of the turned-back channel 271, the elution liquid 277 is caused to quickly flow out from the turned-back channel 271 by the action of a centrifugal force. At that time, if the quantity of the elution liquid 277 flowing from the outermost peripheral side of the elution liquid container 270 toward the inner peripheral side of the turned-back channel 271 is not sufficiently large, there is a risk that the elution liquid 277 having passed the innermost peripheral side of the turned-back channel 271 flows through the turned-back channel 271 while partly filling the channel. Unless the channel sectional area is fully filled with the elution liquid 277 when it flows through the channel, a siphon is not formed in the turned-back channel 271. In such a case, the elution liquid 277 in the elution liquid container 270 residing in the more outer peripheral side than the turned-back channel 271 cannot flow downstream and is stopped just after reaching the position of a liquid level 669. Consequently, a large amount of the elution liquid is left.

To avoid the above-described drawback, the turned-back channel narrowed portion 120 is provided in this embodiment. The provision of the turned-back channel narrowed portion 120 increases the flow resistance of the elution liquid 277 after having passed the innermost peripheral portion of the turned-back channel 271 and suppresses the flow rate of the elution liquid 277. As a result, a siphon is positively formed in the turned-back channel 271 so that the elution liquid 277 can be all flown out with certainty. The turned-back channel narrowed portion 120 may be formed by changing the channel width and/or depth in a discontinuous way or by gradually narrowing the channel sectional area so long as it is positioned downstream of the innermost peripheral portion of the turned-back channel 271.

(5) With the rotation of the holding disk 12 for a predetermined time (step 916), the operation for the serum centrifugal separation is completed and the rotation of the analysis cartridge 2 is stopped.

(6) In a process using the lysis reagent 227 (step 1016), the lysis reagent container to-be-pierced portion 226 is pierced by the piercing unit 13 (step 918). When the holding disk 12 is rotated (step 920), the lysis reagent 227 is caused to flow out from the lysis reagent container 220 by the action of a centrifugal force (step 1018). After passing through the lysis-reagent container turned-back channel 221, the lysis reagent 227 merges into the serum unit-quantity container turned-back channel 318 at a merging point 419 (step 922 and step 1022).

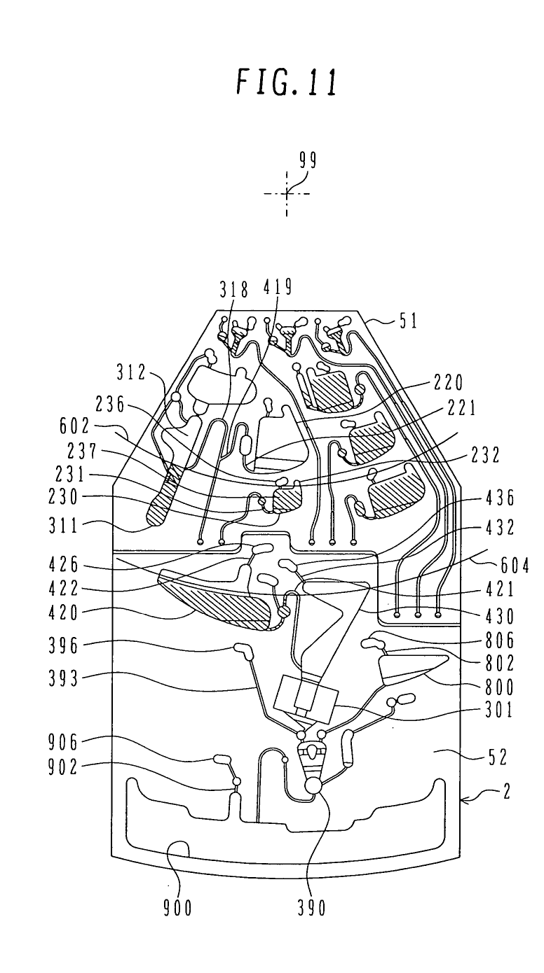

On that occasion, the lysis reagent 227 entrains air in the serum unit-quantity container turned-back channel 318 at the merging point 419 and transfers the air toward the serum reaction container 420. The quantity of air in the serum unit-quantity container turned-back channel 318 is reduced and the serum is attracted toward the merging point 419. Eventually, the serum is forced to move beyond a turned portion at the innermost peripheral position of the serum unit-quantity container turned-back channel 318, whereby a siphon is formed. Once a siphon is formed, the serum continues to flow toward the serum reaction container 420 while merging with the lysis reagent 227 at the merging point 419. When the rotation of the holding disk 12 is continued and the centrifugal force is continuously applied at a sufficient level, the lysis reagent 227 is all flown out except for a small quantity of the remained reagent, and the serum continues to flow out until the serum level is lowered to a position 602 (FIG. 11) at which the serum unit-quantity container turned-back channel 318 is connected to the serum unit quantity container 312. That state is shown in FIG. 11. The serum and the lysis reagent 227 are caused to flow at the same time and to mix with each other in such a way.

In the serum reaction container 420, the mixed serum and lysis reagent 227 react with each other (step 1024). When the mixture of the serum and the lysis reagent 227 flows into the serum reaction container 420, as shown in FIG. 11, the liquid level in the serum reaction container 420 is positioned in the more outer peripheral side than a radial position 604 corresponding to an innermost peripheral portion of a serum reaction container turned-back channel 421. At that time, the mixture of the serum and the lysis reagent 227 does not flow beyond a turned portion of the serum reaction container turned-back channel 421 at its innermost peripheral portion. Thus, the mixture is held in the serum reaction container 420 during the rotation of the holding disk 12.

The lysis reagent 227 acts to dissolve a cell membrane of a virus, a bacterium, etc. in the serum, to enable its nucleic acid to be eluted, and to promote adsorption of the nucleic acid in a binding section 301. Hydrochloric quanidine is used as the reagent for eluting and adsorbing DNA, and guanidine thiocyanate is used as the reagent for eluting and adsorbing RNA. After the mixture of the serum and the lysis reagent 227 has been transferred to the serum reaction container 420, the rotation of the holding disk 12 is stopped (step 924).

(7) Then, the process shifts to a binding mode (step 1026). The cartridge cover 199 covering the to-be-pierced portion 236 of the additional liquid container 230 is pierced by using the piercing unit 13 (step 926). At that time, other four to-be-pierced portions connected to the downstream containers, i.e., a before-binding container to-be-pierced portion 436, a waste container to-be-pierced portion 906, a buffer container to-be-pierced portion 806, and an elution liquid recovery container to-be-pierced portion 396, are also pierced to form outlets for evacuating air occupying in those containers and channels so that the reagents are introduced to the waste container 900 via the binding section 301 and the elution liquid recovery container 390.

After the piercing, the holding disk 12 is rotated (step 928). The additional liquid 237 is caused to move from the additional liquid container 230 into the serum reaction container 420 through an additional liquid turned-back channel 231 by the action of a centrifugal force (step 1028). The additional liquid 237 having flown into the serum reaction container 420 causes the liquid level of the mixture of the serum and the lysis reagent 227 in the serum reaction container 420 to move toward the inner peripheral side. When the liquid level of the mixture reaches the innermost peripheral position 604 of the serum reaction container turned-back channel 421, the mixture flows out toward the downstream side beyond the innermost peripheral position of the serum reaction container turned-back channel 421. Then, the mixture flows into the binding section 301 via the before-binding container 430 (step 1030). Once the mixture of the serum and the lysis reagent 227 exceeds the innermost peripheral position of the serum reaction container turned-back channel 421, a siphon is formed so that the mixture of the serum and the lysis reagent 227 continues to flow into the before-binding container 430. For example, the lysis reagent is used as the additional liquid 237.

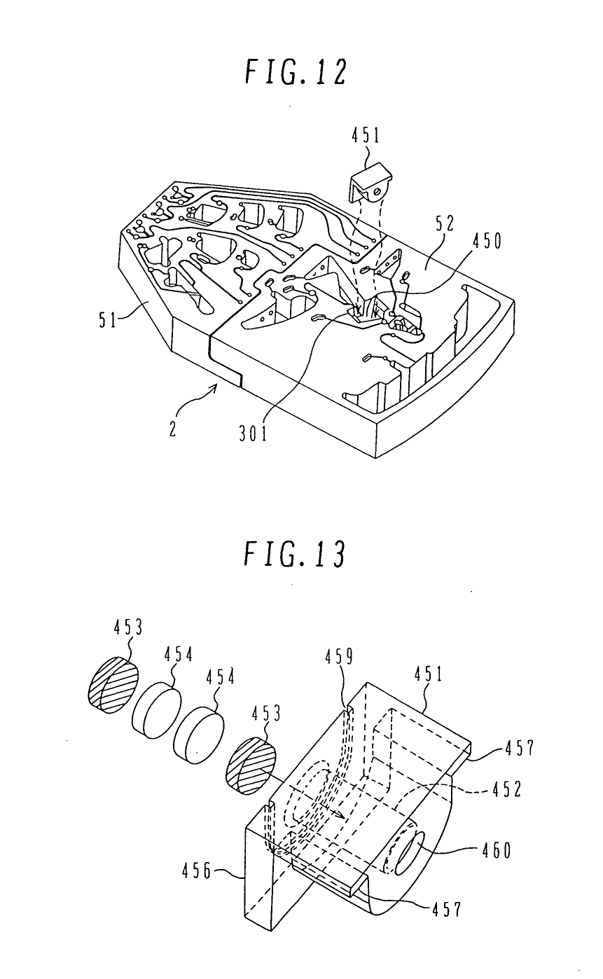

FIG. 12 is a perspective view of the analysis cartridge 2 including the binding section 301. The binding section 301 is obliquely formed substantially in a central area of the reaction cartridge 52. The binding section 301 comprises a recess 450 formed in the reaction cartridge 52 for insertion of a filter holder 451, and the filter holder 451 fitted to the recess 450. A detailed structure of the filter holder 451 is shown in a perspective view of FIG. 13. The filter holder 451 comprises a side plate in the form of a flat rectangular plate, a rectangular ceiling portion positioned above the side plate and extending from the inner peripheral side toward the outer peripheral side of the analysis cartridge 2, and a semi-cylindrical portion positioned under the ceiling portion. A cylindrical filter inserted space 452 having a step 460 is formed in the semi-cylindrical portion to extend from the inner peripheral side toward the outer peripheral side of the analysis cartridge 2.

A plurality of disk-like filters for binding nucleic acids are inserted in the filter inserted space 452. More specifically, two binding filters 454 sandwiched between a pair of filter supports 453 are fast inserted in the filter inserted space 452 so as to abut against the step 460 at an end of the filter inserted space 452. Each of the binding filters 454 is formed of, e.g., a fiber filter of quartz or glass. A groove 459 is formed in a filter insertion-side surface 456 at the front side of the side plate and an adhesive is filled in the groove 459 so that the liquid does not leak through a gap formed between the filter-holder inserted recess 450 and the filter holder 451 when the filter holder 451 is fitted to the recess 450 of the analysis cartridge 2.

The ceiling portion of the filter holder 451 has a flat upper surface, and the flat upper surface of the filter holder 451 is substantially flush with the upper surface of the analysis cartridge 2 when the filter holder 451 is fitted to the recess 450 of the analysis cartridge 2. With such a structure, the cartridge cover 199 can be brought into close contact with the filter holder 451 by adhesion or bonding.

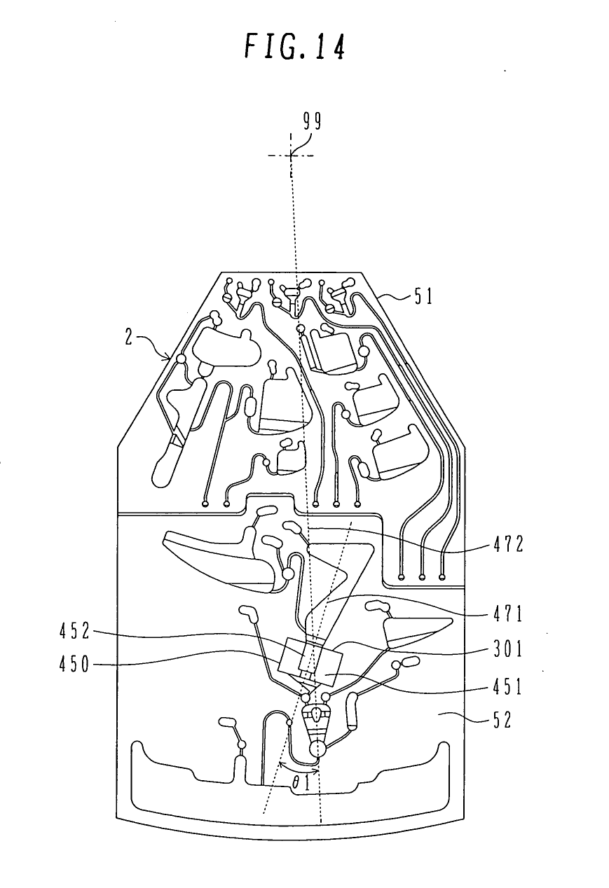

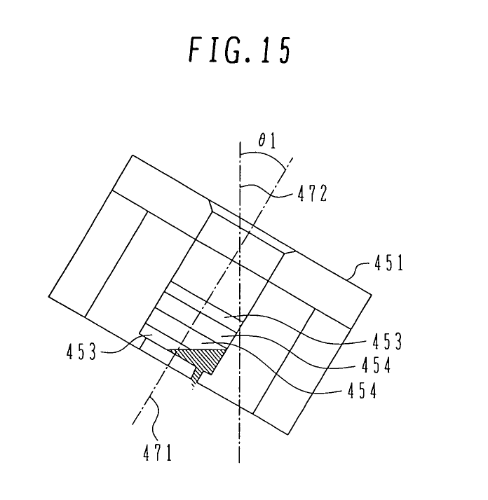

FIG. 14 shows in detail the position where the analysis cartridge 2 is arranged in the filter-holder inserted recess 450, and FIG. 15 shows a state of the liquid inside the filter holder 451 fitted to the filter-holder inserted recess 450. FIG. 14 is a plan view of the analysis cartridge 2. A center axis 471 of the filter inserted space 452 formed in the filter holder 451 is inclined by an angle θ1 from a line 472 interconnecting the center of rotation of the analysis cartridge 2 and the central position of the filter insertion space 452 at its inner peripheral end. The reason why the direction of the binding filters 454 is inclined by an angle θ1 is as follows.

The mixture of the lysis reagent and the serum (i.e., the lysis reaction liquid), the first cleaning liquid, the second cleaning liquid, and the elution liquid flow through the binding section 301. When each of those liquids flows through the binding section 301, a centrifugal force acts on the liquid in the radial direction 472. While flowing through the binding section 301, therefore, each liquid is biasedly collected by the action of the centrifugal force to a corner at one side of the binding filters 454 or the filter supports 453 which are held in the filter-holder inserted recess 450. As a result, the collected liquid can be easily discharged and the quantity of the remained liquid can be reduced. The angle θ1 is set to 5 degrees or larger inclined in the leftward or rightward direction so that the liquid is smoothly discharged.

With such a simple arrangement that the direction of insertion of the binding filters 454 is inclined by the angle θ1, it is possible to reduce the quantity of the remained liquid after passing through the binding filters 454 and to increase the effect of cleaning the binding section 301 by the first cleaning liquid and the second cleaning liquid. Also, since the quantity of the remained solute liquid is reduced, the recovery rate of nucleic acids can be increased. Further, since the direction of insertion of the binding filters 454 is inclined by the angle θ1, an increase in the quantity of the remained liquid can be suppressed even when the generated centrifugal force is somewhat weak. As a result, the gene analysis device 1 can be manufactured by using a motor with a relatively low output.

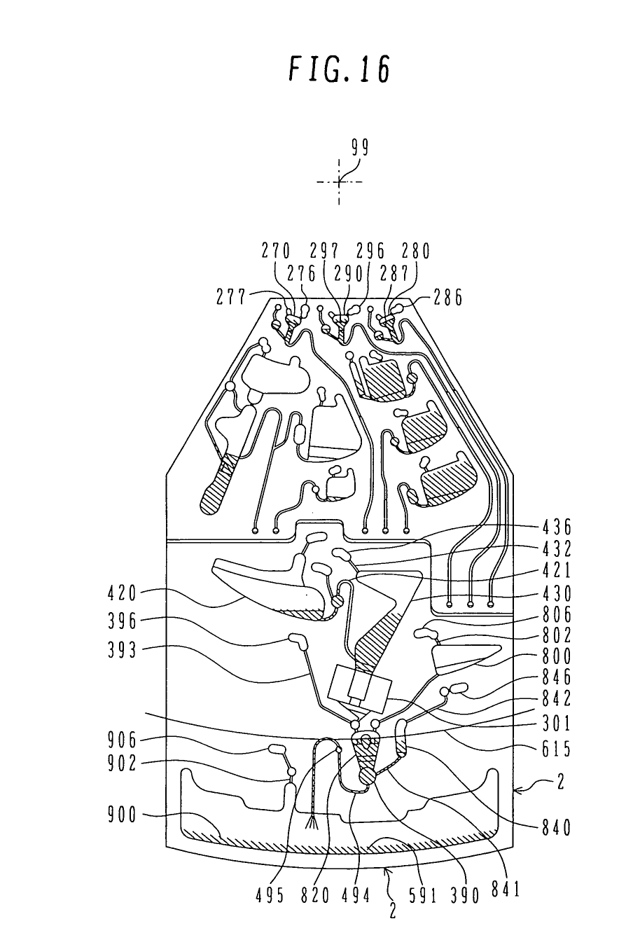

The flow of the mixture of the lysis reagent and the serum and the flow of the liquid waste will be described below with reference to a plan view of the analysis cartridge 2 shown in FIG. 16. When the mixture of the lysis reagent and the serum, i.e., the lysis reaction liquid, passes through the binding section 301 (step 930 and step 1032), nucleic acids are adsorbed onto the binding filters 454 placed in the binding section 301. Liquid waste 591 generated after the mixture has passed through the binding section 301 is caused by the action of a centrifugal force to flow into the elution liquid recovery container 390 connected to the binding section 301. An elution liquid recovery container turned-back channel 494 is connected to the outermost peripheral side of the elution liquid recovery container 390. The elution liquid recovery container turned-back channel 494 is formed to first extend toward the inner peripheral side until a radial position 615 and then to turn back for connection to the waste container 900 at the outer peripheral end.

On that occasion, as in the serum reaction container 420, with the presence of a turned-back portion of the elution liquid recovery container turned-back channel 494, the liquid waste 591 is temporarily held in the elution liquid recovery container 390. Because the quantity of the liquid waste 591 is much larger than the volume of the elution liquid recovery container 390, the liquid waste 591 flows out to the waste container 900 in the downstream side beyond the innermost peripheral position 615 of the elution liquid recovery container turned-back channel 494 as shown in FIG. 16 (step 1034). After the liquid waste 591 has been transferred to the waste container 900, the rotation of the holding disk 12 is stopped (step 932). At that time, by the action of a compressed air container 840 described later, the liquid waste 591 temporarily held in the elution liquid recovery container 390 is all transferred to the waste container 900 except for a very small quantity of the remained liquid waste.

(8) The process shifts to a cleaning mode (step 1036). For supply of air to the first cleaning liquid container 240, a to-be-pierced portion 246 associated with the first cleaning liquid container 240 is pierced (step 934). When the holding disk 12 is rotated again (step 936), the first cleaning liquid is introduced from the first cleaning liquid container 240 to the binding section 301 via the before-binding container 430 by the action of a centrifugal force (step 938 and step 1038). The introduced first cleaning liquid cleans not only the before-binding container 430, but also unnecessary components, such as protein, adhering to the binding filters 254 (step 1040). For example, the above-mentioned lysis reagent or a liquid obtained by reducing the salt concentration of the lysis reagent is used as the first cleaning liquid. The liquid waste generated after cleaning the before-binding container 430 and the binding filters 251 is transferred to the waste container 900 via the elution liquid recovery container 390 similarly to the above-mentioned case of the liquid mixture (step 1042). After the liquid waste has been transferred to the waste container 900, the rotation of the holding disk 12 is stopped (step 940).

Then, the second cleaning liquid is started to flow. In order to clean unnecessary components, such as salt, adhering to the before-binding container 430 and the binding section 301, ethanol or an ethanol aqueous solution is used as the second cleaning liquid. In the state where the rotation of the holding disk 12 is stopped, a second cleaning liquid container to-be-pierced portion 256 is pierced for supply of air to the second cleaning liquid container 250. Thereafter, the holding disk 12 is rotated again to generate a centrifugal force. By the action of the centrifugal force, the second cleaning liquid is introduced from the second cleaning liquid container 250 to the binding section 301 via the before-binding container 430, thereby cleaning the before-binding container 430 and the binding filters 254. The liquid waste after the cleaning is transferred to the waste container 900 via the elution liquid recovery container 390 similarly to the case of the first cleaning liquid mixture. After the liquid waste has been transferred to the waste container 900, the rotation of the holding disk 12 is stopped (steps 1038-1042).

Likewise, a third cleaning liquid container to-be-pierced portion 266 is pierced for supply of air to the third cleaning liquid container 260. The third cleaning liquid flows into the elution liquid recovery container 390 via the buffer container 800. The third cleaning liquid cleans salt adhering to the elution liquid recovery container 390 and a very small amount of the remained second cleaning liquid. For example, sterilized water or an aqueous solution adjusted to pH 7-9 is used as the third cleaning liquid. After cleaning the binding section 301 and the elution liquid recovery container 390, the holding disk 12 is stopped for shift to a nucleic-acid elution process (step 940).

(9) The process shifts to an elution mode (step 1044). The elution liquid container to-be-pierced portion 276 is pierced for supply of air to the elution liquid container 270 (step 942). At that time, the cartridge cover 199 covering a compressed air container to-be-pierced portion 846 is also pierced to communicate the compressed air container 840 with the outside through a compressed air container air channel 842. By piercing the compressed air container to-be-pierced portion 846, as described later, the elution liquid, the first amplification liquid, and the second amplification liquid can be held the elution-liquid recovery container 390. The holding disk 12 is rotated (step 944), thus causing the elution liquid 277 to flow into the binding section 301 (step 1046). Water or an aqueous solution adjusted to pH 7-9 is used as the elution liquid 277. The elution liquid 277 elutes the nucleic acids from the binding filters 454 in the binding section 301 (step 946 and step 1048). Having passed through the binding section 301, the elution liquid 277 including the eluted nucleic acids is recovered in the elution liquid recovery container 390 (step 1050). The rotation of the holding disk 12 is stopped (step 948).

(10) The process shifts to an amplification and detection mode (step 1052). A first amplification liquid container to-be-pierced portion 296 is pierced for supply of air to the first amplification liquid container 290. The motor 11 is rotated, whereby the first amplification liquid 297 passes through the buffer container 800 and flows into the elution liquid recovery container 390. The first amplification liquid 297 is a reagent for amplifying and detecting the nucleic acids and contains, for example, deoxynucleoside triphosphate, a fluorescent reagent, etc. The motor 11 is then stopped.

After the first amplification liquid 297 has flown into the elution liquid recovery container 390, the humidifier 14 is moved to a position near the elution liquid recovery container 390 of the analysis cartridge 2. Alternatively, the holding disk 12 is rotated such that the analysis cartridge 2 is moved to a position near the humidifier 14. The temperature of the elution liquid recovery container 390 is controlled by using the humidifier 14. A second amplification liquid container to-be-pierced portion 286 is pierced for supply of air to the second amplification liquid container 280. The motor 11 is rotated. By the action of a centrifugal force, the second amplification liquid 287 passes through the buffer container 800 and flows into the elution liquid recovery container 390. The second amplification liquid 287 contains an enzyme required for amplification. The quantities of the elution liquid, the first amplification liquid, and the second amplification liquid are set such that, when those three types of liquids are all transferred to the elution liquid recovery container 390, the liquid level is positioned in the more outer peripheral side than the innermost peripheral position 615 of the turned-back channel 494 of the elution liquid recovery container 390.

After the second amplification liquid 287 has flown into the elution liquid recovery container 390, the humidifier 14 is moved to the position near the elution liquid recovery container 390 of the analysis cartridge 2, or the holding disk 12 is rotated such that the analysis cartridge 2 is moved to the position near the humidifier 14. The temperature of the elution liquid recovery container 390 is controlled by using the humidifier 14. While the temperature control is performed for a predetermined time, the nucleic acids are amplified and detected by the detector 15 (step 1054). The humidification is continued for a time required for the amplification and the detection, e.g., 30 minutes to 2 hours. In the elution liquid recovery container 390 into which the second amplification liquid 287 has flown, a mixture of the elution liquid, the first amplification liquid, and the second amplification liquid, i.e., an amplification reaction liquid, is held.

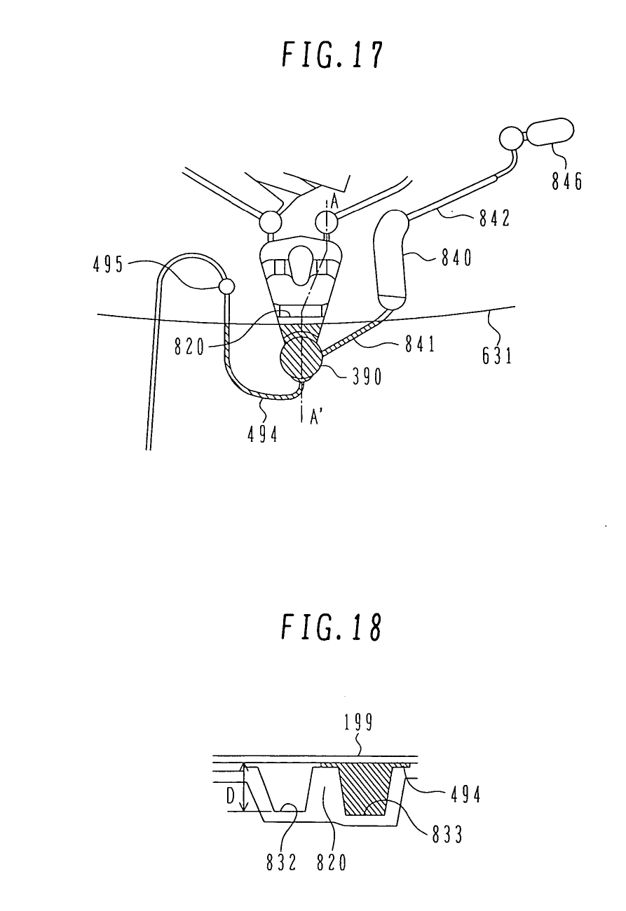

The state of the amplification reaction liquid around the elution liquid recovery container 390 at that time will be described below with reference to FIGS. 17 and 18. FIG. 17 is a plan view and FIG. 18 is a sectional view taken along line A-A′ in FIG. 17. A partition 820 is disposed in the elution liquid recovery container 390 to divide the interior of the elution liquid recovery container 390 into a first space 833 located in the outer peripheral side and a second space 832 located in the inner peripheral side. The partition 820 has a height set to leave a slight gap between a top of the partition 820 and the cartridge cover 199 so that liquid flow is not stopped.

The dimensions of the elution liquid recovery container 390 is set such that, when the elution liquid, the first amplification liquid, and the second amplification liquid are all transferred to the elution liquid recovery container 390, the liquid level in the elution liquid recovery container 390 is located at the partition 820 or at a position in the more inner peripheral side than the partition 820, but in the more outer peripheral side than the innermost peripheral position and a channel enlarged portion 495 of the turned-back channel 494 of the elution liquid recovery container 390. Further, the compressed air container 840 is positioned in the more inner peripheral side than a liquid level 631, and the liquid level 631 is positioned in a compressed air container coupling channel 841.

The interface between the amplification reaction liquid and air is positioned in each of the elution liquid recovery container turned-back channel 494 and the compressed air container coupling channel 841, and at the partition 820. Accordingly, an evaporation area, i.e., an area of the interface between the liquid and air, is small and the evaporation of the liquid during the process of amplification and detection can be reduced. Also, because the first space 833 is fully filled with the liquid, there is no interface between the liquid and air. By using an upper or lower surface of the first space 833 as a detection surface, the detection can be stably performed without being affected by the liquid-air interface. A depth D of the second space 832 is set to be substantially equal to that of the first space 833. The reason is as follows. If the second space 832 is too shallow, the liquid level is varied depending on a slight difference in quantity of the amplification reaction liquid, thus resulting in a risk that the amplification reaction liquid may flow out through the turned-back channel 494 even with a slight increase of the liquid quantity.

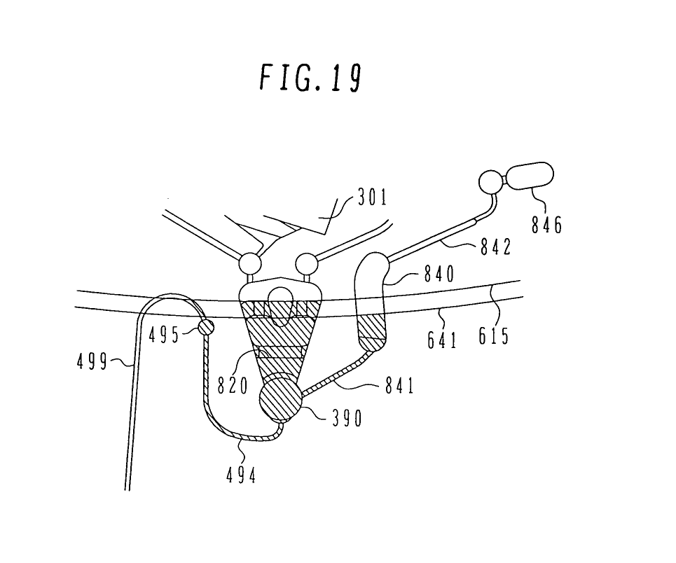

FIG. 19 shows in detail a situation around the elution liquid recovery container 390 when the lysis reaction liquid (i.e., the mixture of the lysis reagent and the serum) or each of the first to third cleaning liquids passes through the elution liquid recovery container 390. If the amplification reaction liquid flows into the elution liquid recovery container 390 in a state where the lysis reaction liquid or any of the first to third cleaning liquids remains therein, the process in the amplification and detection mode is adversely affected. For that reason, those liquids must be completely discharged before the amplification reaction liquid flows into the elution liquid recovery container 390.

In FIG. 19, the holding disk 12 is rotated to make a centrifugal force act upon the analysis cartridge 2, whereby the lysis reaction liquid is flown into the elution liquid recovery container 390 through the binding section 301. Because the binding filters are placed in the binding section 301, the flow rate of the lysis reaction liquid flowing into the elution liquid recovery container 390 is very small. This leads to a difficulty in forming a siphon in the turned-back channel 494 of the elution liquid recovery container 390. Therefore, the lysis reaction liquid flows downstream through the turned-back channel 494 in an intermittent way or flows in the form of a biased flow 499 through the turned-back channel 494. When the lysis reaction liquid is completely flown out from the binding section 301 without forming a siphon, the lysis reaction liquid remains in the elution liquid recovery container 390 while it takes a liquid level indicated by 615.

At the time when the lysis reaction liquid flows into the elution liquid recovery container 390, the to-be-pierced portion 846 connected to the compressed air container 840 is not yet pierced. Air in each of the to-be-pierced portion 846, the air channel 842, and the compressed air container 840 is enclosed and compressed in spaces defined therein. When the analysis cartridge 2 is rotated and the lysis reaction liquid is caused to enter the compressed air container 840 by the action of a centrifugal force, the liquid level 641 is going to rise up toward the liquid level 615 in the more inner peripheral side. However, the rise of the liquid level 641 is suppressed by the inner pressure in the compressed air container 840 and is balanced, as indicated by 641, at a position in the more outer peripheral side than the liquid level 615. As the rotational speed of the analysis cartridge 2 increases, the liquid level 641 comes closer to the liquid level 615.

Upon coming into a state where the lysis reaction liquid is completely flown out from the binding section 301 and remains in the elution liquid recovery container 390 at a liquid level indicated by 615, the rotational speed of the analysis cartridge 2 is reduced to weaken the centrifugal force. Correspondingly, the liquid level 641 is moved toward the outer peripheral side, and the liquid in the compressed air container 840 flows into the elution liquid recovery container 390. The liquid having flown into the elution liquid recovery container 390 raises the liquid level 615 in the elution liquid recovery container 390. At the same time, the liquid advances in the turned-back channel 494 from the outer peripheral end of the elution liquid recovery container 390 such that the turned-back channel 494 is filled with the liquid. As a result, a siphon is formed in the turned-back channel 494, thus enabling the lysis reaction liquid in the elution liquid recovery container 390 to be all discharged toward the downstream side.

In order to realize the above-described process, the compressed air container 840 is arranged such that a part of the compressed air container 840 is located in the more outer peripheral side than the innermost peripheral portion of the elution liquid recovery container turned-back channel 494. With such an arrangement, the lysis reaction liquid is allowed to flow into the compressed air container 840 when it is caused to flow by the action of the centrifugal force. Also, when the rotational speed of the analysis cartridge 2 is reduced, it is desired to reduce the rotational speed promptly. With the prompt reduction of the rotational speed, the liquid in the compressed air container 840 is more easily moved to the elution liquid recovery container 390 and the turned-back channel 494 is more easily filled with the liquid. Hence a siphon is more positively formed. While the above description is made in connection with the lysis reaction liquid, it is similarly applied to the case where each of the first to third cleaning liquids flows into the elution liquid recovery container 390.

The above-described formation of a siphon by utilizing compressed air as in this embodiment can be widely applied to various fields in the case of temporarily holding a liquid in a container and then causing the liquid to flow again from the container. For example, if a compressed air container is connected to the serum reaction container 420, it is no longer required to make the lysis reaction liquid flow by using the additional liquid. Prior to starting flow of each of the elution liquid, the first amplification liquid, and the second amplification liquid, the compressed air container to-be-pierced portion 846 is pierced to be communicated with the outside. As a result, the flow of the amplification reaction liquid is not affected by the inner air pressure, and the amplification reaction liquid can be held in the elution liquid recovery container 390.

Since the compressed air container 840 is arranged in the more inner peripheral side than the liquid level 631 of the amplification reaction liquid and is connected to the elution liquid recovery container 390 through the compressed air container coupling channel 841, the liquid level 631 of the amplification reaction liquid is positioned in the compressed air container coupling channel 841 and at the partition 820. It is therefore possible to reduce the liquid-air interface and to suppress the evaporation of the liquid. This eliminates the need of the operation of closing the pierced hole, for example, in order to prevent the liquid from evaporating after the piercing.

Since the first space 833 located in the more outer peripheral side than the partition 820 is filled with the amplification reaction liquid, the liquid-air interface can be avoided from impeding the detection by detecting the amplification reaction liquid with the detector 15 arranged at the inner or outer peripheral end of the first space 833. While the partition 820 is provided in the form of a wall having a height smaller than the depth of the first and second spaces, it may have other suitable shape so long as the presence of the partition is effective in reducing the evaporation area. For example, the partition may be formed as a channel for connecting the first and second spaces to each other.

Since the elution liquid recovery container 390 is associated with the turned-back channel 494 including the turned-back portion and with the compressed air container 840 extending to a position in the more inner peripheral side than the turned-back channel 494, the liquid can be easily discharged based on the siphoning action. Further, by controlling the air occupying the compressed air container 840, etc. and the rotational speed of the analysis cartridge 2, a siphon can be positively formed. According to this embodiment, the flow of the liquid can be controlled with a simple construction with no need of providing a special valve.

In the above-described embodiment, the elution liquid retreat container is pierced in advance to be communicated with the outside. However, because the elution liquid can be flown in some quantity to the elution liquid retreat container without establishing communication with the outside, the elution liquid retreat container is not always required to be communicated with the outside when the necessary amount of the elution liquid is small. This point is also similarly applied to any of the other retreat containers. Alternatively, by communicating the retreat container with the outside in advance, the reagent can be more positively held in the container. While the humidifier 14 and the detector 15 are separately provided in the above-described embodiment, they can be constituted in an integral unit such that the humidification and the detection are performed in the same position. Furthermore, while the humidifier and the detector are disposed on the upper surface of the holding disk 12 in the above-described embodiment, they may be disposed on a lower surface of the holding disk.

1. A chemical analysis device comprising a rotatable holding disk and a plurality of analysis cartridges arranged side by side along a circumference of said holding disk,
wherein each of said plurality of analysis cartridges comprises a reagent cartridge having a plurality of reagent containers formed therein to be able to contain reagents, and a reaction cartridge connected to said reagent cartridge and having a reaction container formed therein, said reagent cartridge and said reaction cartridge being each made up of a base plate and a cover covering recesses formed in a surface of said base plate, and
channels for interconnecting said plurality of reagent containers and said reaction container are formed in said reagent cartridge and said reaction cartridge, said channels being formed inside the base plates of said reagent cartridge and said reaction cartridge in connected portions thereof.

2. A chemical analysis device comprising a rotatable holding disk and a plurality of analysis cartridges arranged side by side along a circumference of said holding disk,
wherein each of said plurality of analysis cartridges comprises a plurality of reagent containers capable of containing reagents, channels for transferring the reagents toward the outer peripheral side from said reagent containers, and a reaction container connected to said channels and arranged in the outer peripheral side of said reagent containers.

3. The chemical analysis device according to claim 2, wherein each of said channels connected to said reagent containers is a turned-back channel extending toward the inner peripheral side to some extent and further extending toward the outer peripheral side, and a channel enlarged portion having an increased channel sectional area is formed in a portion of said turned-back channel extending toward the inner peripheral side.

4. The chemical analysis device according to claim 2, wherein each of said channels connected to said reagent containers is a turned-back channel extending toward the inner peripheral side to some extent and further extending toward the outer peripheral side, and the turned-back channel has a narrowed portion formed in a portion extending toward the outer peripheral side.

5. The chemical analysis device according to claim 2, wherein each of said channels connected to said reagent containers is a turned-back channel connected to said reagent container at an outer peripheral portion thereof, extending toward the inner peripheral side to some extent, and further extending toward the outer peripheral side, and an air channel and a retreat container connected to said air channel are provided in the course of said turned-back channel or at an end of a channel branched from said reagent container, said retreat container being arranged in the more inner peripheral side than an outer peripheral end of said reagent container.

6. The chemical analysis device according to claim 2, wherein said analysis cartridge includes a binding section for capturing or binding a material in a specimen, and a filter holder for holding a binding filter is attached to said binding section, said filter holder being arranged such that said binding filter is inserted in a direction inclined from the radial direction of said holding disk.

7. The chemical analysis device according to claim 6, wherein said filter holder is held in said reaction cartridge such that an upper surface of said filter holder is substantially flush with an upper surface of a base plate of said reagent cartridge.

8. The chemical analysis device according to claim 1, wherein said analysis cartridge includes a specimen holding container for holding a specimen, a detection container for detecting at least one component contained in the specimen from a reaction liquid generated with reaction occurred in said reaction container, and a recovery container for recovering a liquid discharged from said detection container.

9. The chemical analysis device according to claim 8, wherein said detection container includes a partition for dividing the interior of said detection container into a first portion in the outer peripheral side and a second portion in the inner peripheral side, and the partition is arranged such that a liquid level of the reaction liquid is positioned at said partition.

10. The chemical analysis device according to claim 8, wherein said detection container is connected to a turned-back channel extending from an outer peripheral end of said detection container toward the inner peripheral side to some extent and further extending toward the outer peripheral side, and a compressed air container having at least part thereof positioned in the more outer peripheral side than an innermost peripheral portion of said turned-back channel is connected to said detection container.

11. The chemical analysis device according to claim 8, wherein a compressed air container is connected to said reaction container, compressed air is generated in said a compressed air container by rotating said rotatable holding disk, and the compressed air is expanded by reducing a rotational speed of said rotatable holding disk, thereby moving the liquid in said reaction container.
